(19) United States
(12) Patent Application Publication
(10) Pub. No.: US 2010/0022192 A1
(43) Pub. Date: Jan. 28, 2010

(54) Systems and Methods for Transmitter/Receiver Diversity

(75) Inventors: Mikael Bergholz Knudsen, Gistrup (DK); Peter Bundgaard, Aalborg (DK); Bernd Adler, Neubiberg (DE)

Correspondence Address: LEE & HAYES, PLLC, 601 W RIVERSIDE AVENUE, SUITE 1400, SPOKANE, WA, 99201, US

(73) Assignee: Infineon Technologies AG, Neubiberg (DE)

(21) Appl. No.: 12/179,143

(22) Filed: Jul. 24, 2008

(51) Int. Cl. H04B 7/00

(52) U.S. Cl. 455/70

(57) ABSTRACT

Systems and methods for transmitter/receiver diversity for wireless communication systems are described herein.

### BACKGROUND

Wireless communication systems, such as those used in the mobile communication industry, are facing ever-increasing demands for high data rate applications (e.g. videophone, etc.) to better compete with wired systems. Standards like High Speed Downlink Packet Access (HSDPA) and High Speed Uplink Packet Access (HSUPA) are being developed within the Universal Mobile Telecommunications System (UMTS) mobile phone standard. The increasing demand for higher data rates is accompanied by an increasing demand for higher signal quality at both the mobile terminal and the base station.

For a mobile terminal at the edge of a cell, signal quality may be limited by thermal noise and the noise figure of the receiver, as well as the channel quality (fading). These factors may adversely impact the reliability of data transfer. As the distance between the mobile terminal and the base station decreases, signal quality typically improves. In conventional wireless communication systems, the area in which reliable high data transfer becomes feasible is typically limited to only a portion of the cell close to the base station, and may have a radial extent that is less than half that of the entire cell.

To widen the active area for reliable high-speed data transmissions, one possible solution is to simply increase the number of base stations (e.g. cell towers) to minimize the maximum distance to the mobile terminal. This solution has the disadvantages of vastly increased infrastructure costs and reduced environmental aesthetics. Therefore, methods and systems that provide improved signal quality necessary for reliable high-speed data transmissions over a greater portion of the cell area would have considerable utility.

### BRIEF DESCRIPTION OF THE DRAWINGS

The detailed description is described with reference to the accompanying figures. The use of the same reference numbers in different instances in the description and the figures may indicate similar or identical items.

FIG. 1 is an exemplary environment in which techniques in accordance with the present disclosure may be implemented.

FIG. 2 is an exemplary wireless communication component of the environment of FIG. 1 in accordance with an implementation of the disclosure.

FIG. 3 is an exemplary switch of the wireless communication component of FIG. 2 in a first configuration in accordance with an implementation of the disclosure.

FIG. 4 is the exemplary switch of FIG. 3 in a second configuration in accordance with an implementation of the disclosure.

FIGS. 5 and 6 are flowcharts of processes for providing wireless signals in accordance with alternate implementations of the present disclosure.

### DETAILED DESCRIPTION

Disclosed herein are improved systems and methods for transmitter/receiver diversity for wireless communication systems. Implementations in accordance with the present disclosure may provide improved signal quality over greater distances in comparison with conventional systems and methods.

In general, implementations in accordance with the present disclosure may expand the range of high data rate communication feasibility by increasing the signal quality at the mobile terminal using a second receiver chain. This technique may be termed a diversity receiver. More specifically, implementations in accordance with the present disclosure may provide transmission and reception diversity in a multiband, multimode Global System for Mobile Communications (GSM) or Universal Mobile Telecommunication System (UMTS) engine.

Providing a mobile terminal with two antennas may have considerable advantages, because transmitting on one of the antennas will typically give a better signal quality at the base station than on the other antenna. It will, however, not always be the same antenna that provides the best transmission performance, because some of the effects degrading the transmission performance are dynamic, such as fading and user interaction (e.g. finger, hand, head covering/detuning one of the antennas, etc.). To determine which antenna is best for transmitting, implementations in accordance with the present disclosure provide a second full chain receiver branch. The signal from each reception branch is continuously monitored, and the transmission antenna is selected based on a comparison of the reception signals of each of the receiver branches, as described more fully below.

Systems and methods in accordance with the present disclosure may be implemented in a number of suitable ways. An exemplary environment and an exemplary system for implementing such techniques are described in the following section.

Exemplary Environment and System

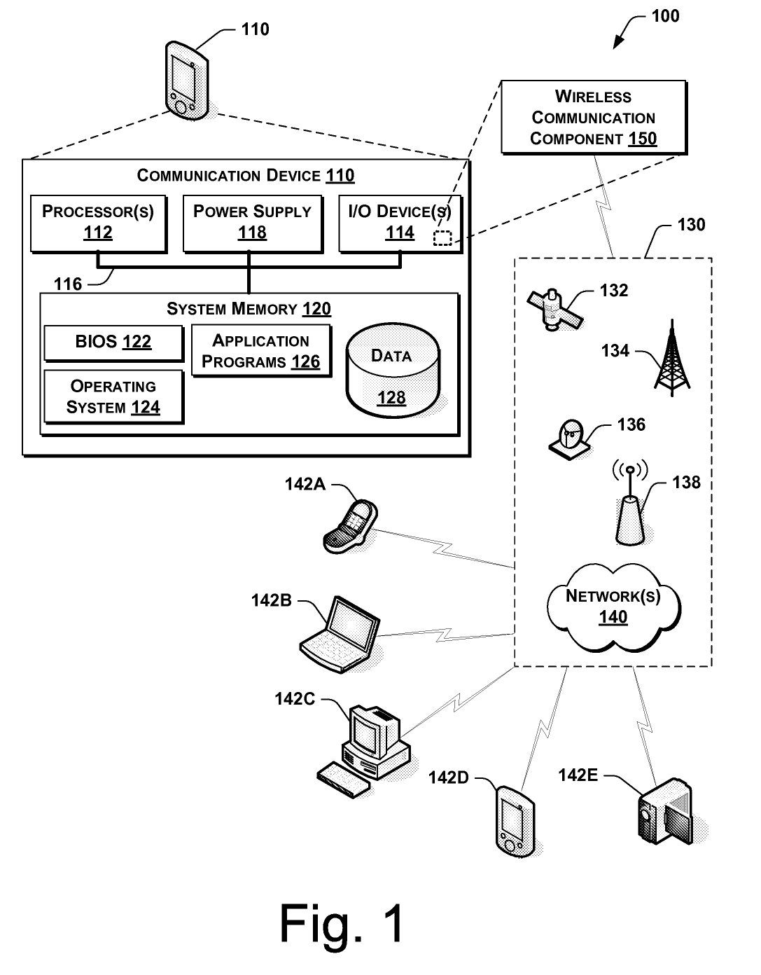

FIG. 1 illustrates an exemplary environment 100 in which techniques in accordance with the present disclosure may be implemented. In this implementation, the environment 100 includes a communication device 110 having at least one input/output (I/O) device 114. The I/O device 114 includes a wireless communication component 150 configured in accordance with the teachings of the present disclosure.

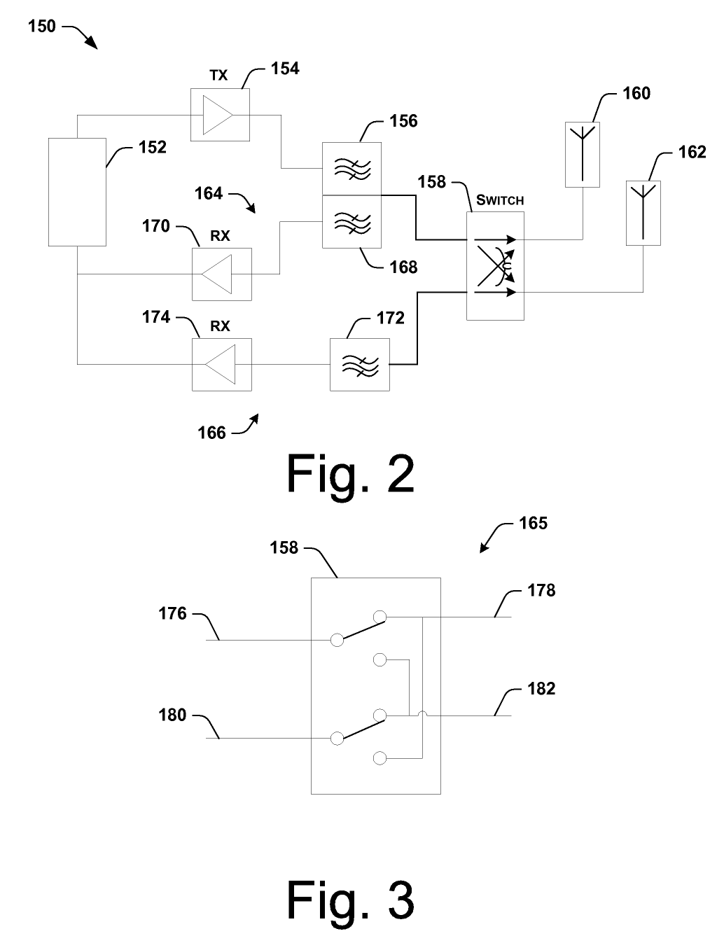

In this environment 100, the communication device 110 wirelessly communicates via an infrastructure 130 with a plurality of other devices 142. Additionally or alternatively, the communication device 110 may bypass the infrastructure 130 and wirelessly communicate directly with one or more of the other devices 142, or may simply communicate with the infrastructure 130 itself. The communication device 110 may be a cellular telephone, a personal data assistant (PDA), a global positioning system (GPS) unit, or any other suitable device that performs wireless communications. Detailed descriptions of various aspects of the wireless communication component 150 are provided in the following sections with reference to FIGS. 2 through 4.

In some implementations, the infrastructure 130 may include a variety of suitable components that cooperatively provide a wireless communications functionality. Various exemplary communication components of the infrastructure 130 are shown in FIG. 1 for illustrative purposes. For example, in some implementations, the infrastructure 130 may include one or more of the following: a communications satellite 132, an antenna tower 134, a communications dish 136, a signal carrier 138, and one or more networks 140. Alternately, other communications components may be used. In particular implementations, for example, the infrastructure 130 may include those components that make up a Core Network (CN) and a UMTS Terrestrial Radio Access Network (UTRAN) of a modern UMTS (Universal Mobile Telecommunication System).

Other devices 142 may communicate with the communication device 110 (or with one or more of the other devices 142) via the infrastructure 130, or with the infrastructure 130 itself. The other devices 142 in the environment 100 may include, for example, a cellular telephone 142A, a laptop or mobile computer 142B, a desktop computer 142C, a hand-held device 142D (e.g. cellular telephone, personal data assistant (PDA), global positioning system (GPS), radio, television, audio device, signal processor, etc.), and a video transmission device 142E (e.g. videophone, video camera, etc.). Of course, the devices 142 may comprise any other suitable devices, and it is understood that any of the other devices 142 of the environment 100 may be equipped to communicate wirelessly using a wireless communication component in accordance with the teachings of the present disclosure (e.g. wireless communication component 150).

As further shown in FIG. 1, in this implementation, the communication device 110 includes one or more processors 112 and one or more input/output (I/O) devices 114 coupled to a system memory 120 by a bus 116. Power may be provided to the components of the communication device 110 via a power supply 118. In this implementation, the wireless communication component 150 is depicted as a component of the one or more I/O devices 114, however, in alternative implementations, the wireless communication component 150 may be separate from the I/O devices 114, or may be integrated with any other suitable portion of the communication device 110.

The system bus 116 of the communication device 110 represents any of the several types of bus structures, including a memory bus or memory controller, a peripheral bus, an accelerated graphics port, and a processor or local bus using any of a variety of bus architectures. The I/O component 114 may be configured to operatively communicate with one or more external networks 140, such as a cellular telephone network, a satellite network, an information network (e.g., Internet, intranet, cellular network, cable network, fiber optic network, LAN, WAN, etc.), an infrared or radio wave communication network, or any other suitable network.

The system memory 120 may include computer-readable media configured to store data and/or program modules for implementing the techniques disclosed herein that are immediately accessible to and/or presently operated on by the processor 112. For example, the system memory 120 may also store a basic input/output system (BIOS) 122, an operating system 124, one or more application programs 126, and program data 128 that can be accessed by the processor 112 for performing various tasks desired by a user of the communication device 110.

Moreover, the computer-readable media included in the system memory 120 can be any available media that can be accessed by the device 110, including computer storage media and communication media. Computer storage media may include both volatile and nonvolatile, removable and non-removable media implemented in any method or technology for storage of information such as computer-readable instructions, data structures, program modules, or other data. Computer storage media includes, but is not limited to, and random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information and which can be accessed by the communication device 110.

Similarly, communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Generally, program modules executed on the communication device 110 (FIG. 1) may include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

Although the exemplary environment 100 in FIG. 1 is shown as a communication network, this implementation is meant to serve only as a non-limiting example of a suitable environment for use of the wireless communication device 150 in accordance with present disclosure. Similarly, the devices 110, 142 are simply non-limiting examples of suitable devices that may include wireless communication devices in accordance with the teachings of the present disclosure.

Wireless Communication Component

Structural and operational aspects of implementations of wireless communication components in accordance with the present disclosure will now be described. For example, FIG. 2 is an exemplary wireless communication component 150 in accordance with an implementation of the present disclosure.

As shown in FIG. 2, in this implementation, the wireless communication component 150 includes a controller 152 that supplies information signals (e.g. data, information, etc.) that are to be transmitted by the communication device 110. The controller 152 may also provide control signals for controlling one or more of the other components of the wireless communication component 150. In alternate implementations, at least one of the information signals or the control signals may be provided by the processor 112 (FIG. 1). In further implementations, all of the functions of the controller 152 described herein may be performed by the processor 112, and the controller 152 may be eliminated.

A transmitter 154 receives the information signals from the controller 152 and modulates communication signals with the information signals for subsequent transmission. A filter 156 filters the modulated communication signals (e.g. band-pass filtered) before providing the modulated communication signals to a switch 158. In some implementations, the switch 158 may be a Double Pole Double Throw (DPDT) switch. The switch 158 is configured to selectively provide the modulated communication signals to a first antenna 160 and a second antenna 162. Each of the first and second antennas 160, 162 may operate on different frequencies.

As further shown in FIG. 1, the wireless communication device 150 further includes a first receiver chain 164 and a second receiver chain 166. The first receiver chain 164 includes a second filter 168 (e.g. a band-pass filter) and a first receiver 170, while the second receiver chain 166 includes a third filter 172 and a second receiver 174. The switch 158 is further configured to selectively provide incoming signals received by the first and second antennas 160, 162 to the first and second receiver chains 164, 166. Each of the first and second receivers 170, 174 are configured to demodulate the incoming signals received by the first and second antennas 160, 162 and to provide the demodulated signals to the controller 152 for subsequent use by the wireless communication component 150.

FIG. 3 is an exemplary implementation of the switch 158 of the wireless communication component 150 of FIG. 2. In this implementation, the switch 158 is of a type known as a Double Pole Double Throw (DPDT) switch. The switch 158 includes a first lead 176 that is coupled to the transmitter 154 (via the first filter 156), and is also coupled to the first receiver 170 (via the second filter 168). A second lead 178 is coupled to the first antenna 160. A third lead 180 is coupled to the second receiver 164 (via the third filter 172), and a fourth lead 182 is coupled to the second antenna 162.

In operation, the switch 158 may be configured in a first configuration 165 as shown in FIG. 3 such that the modulated communication signals from the transmitter 154 are received on the first lead 176 and directed to the second lead 178. The modulated communication signals from the transmitter 154 are then transmitted by the first antenna 160. Incoming signals received by the first antenna 160 are received on the second lead 178 and directed by the switch 158 to the first receiver 170 (via the second filter 168).

Similarly, in the first configuration 165 shown in FIG. 3, incoming signals received by the second antenna 162 are received on the fourth lead 182, and are directed by the switch 158 to the third lead 180, and on to the second receiver 174 (via the third filter 172). Thus, while the modulated communication signals are being transmitted by the first antenna 160, the incoming signals received by the first antenna 160 are monitored by the first receiver 170, and the incoming signals received by the second antenna 162 are monitored by the second receiver 174.

The incoming signals received by the first and second antennas 160, 162 are monitored continuously (or approximately continuously) by the controller 152 to determine which of the antennas 160, 162 are providing higher quality input. If the controller 152 determines that the first antenna 160 is providing higher quality input than the second antenna 162, the switch 158 is maintained in the first configuration 165 (FIG. 3). If the controller 152 determines that the second antenna 162 is providing higher quality input than the first antenna 160, the controller 152 may send control signals to reconfigure the switch 158 such that the modulated communication signals from the transmitter 154 are directed to the second antenna 162 for transmission.

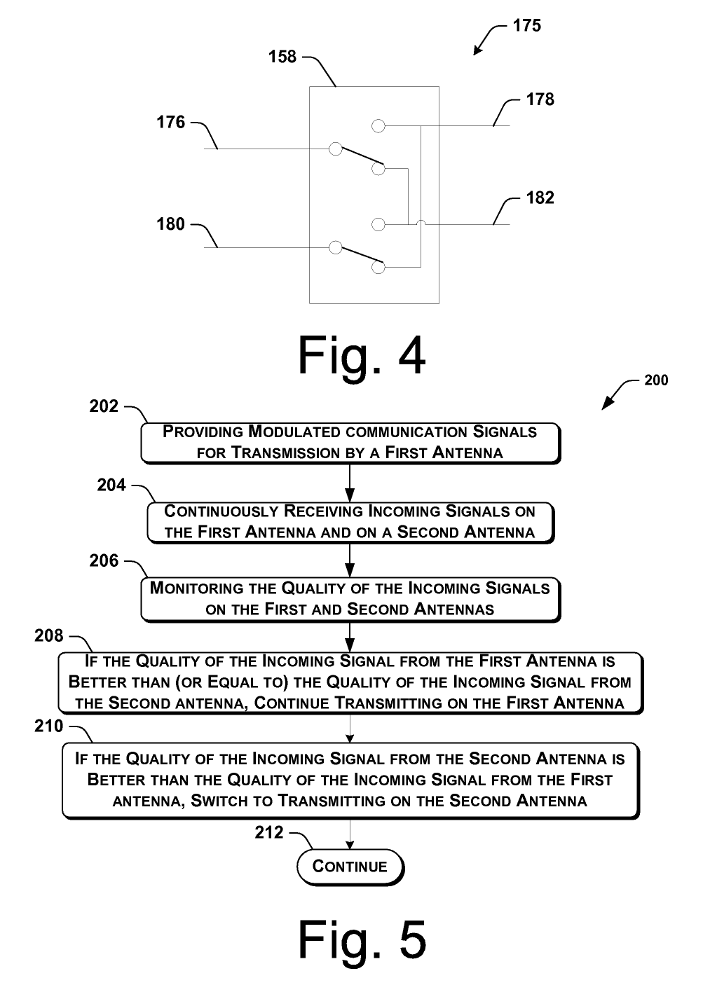

More specifically, FIG. 4 is the exemplary switch 158 of FIG. 3 in a second configuration 175. In the second configuration 175, the modulated communication signals from the transmitter 154 are received by the switch 158 on the first lead 176 and are routed to the fourth lead 182 for transmission by the second antenna 162. Incoming signals received by the first antenna 160 are received on the second lead 178 and directed by the switch 158 to the second receiver 174 on the third lead 180. Similarly, incoming signals received by the second antenna 162 are received on the fourth lead 182, and are directed by the switch 158 to the first receiver 170 on the first lead 176. Thus, while the modulated communication signals are being transmitted by the second antenna 162, the incoming signals received by the first antenna 160 are monitored by the second receiver 174, and the incoming signals received by the second antenna 162 are monitored by the first receiver 170. The controller 152 may continue to continuously monitor the incoming signals received by the first and second antennas 160, 162 to determine whether to continue transmitting on the second antenna 162 (e.g. second configuration 175, FIG. 4), or to reconfigure the switch 158 for transmitting on the first antenna 160 (e.g. second configuration 165, FIG. 3).

Implementations in accordance with the teachings of the present disclosure may provide considerable advantages. In a Frequency Division Duplex (FDD) system such as UMTS and GSM, transmitting and receiving may be accomplished on different frequencies. Therefore, the instantaneous degrading factors (e.g. fading) are typically different for receiving and transmitting. Including the effect of the user (hand, head, etc.), statistical results for UMTS have shown that typically the best antenna for receiving is also the best for transmitting. In at least some conventional systems having two antennas and a single chain transceiver, the best antenna for transmitting is determined by the received signal quality. The conventional arrangement, however, requires occasionally switching to the other antenna to determine if that other antenna has the better receiving quality, which gives some slots with non-optimum reception and transmission.

On the other hand, implementations in accordance with the teachings of the present disclosure advantageously support both transmission selection diversity and reception diversity by providing two (or more) receiver branches 164, 166 for an FDD system. By providing the wireless communication device 150 having the first and second receiver branches 164, 166, the switch 158, and the first and second antennas 160, 162, implementations in accordance with present disclosure provide the wireless communication device 150 with full chain reception diversity, as well as transmission diversity, in an FDD radio frequency (RF) engine of a multiband multimode GSM/UMTS device.

It will be appreciated that the wireless communication component 150 described above, and sub-components thereof, are merely exemplary implementations, and that a variety of alternate implementations may be conceived. For example, alternate implementations may be conceived that use other types of switches, and not merely the DPDT switch 158 described above and shown in the accompanying figures. Also, in further implementations, additional antennas, receiver chains, and switching capability may be added.

Exemplary Process

An exemplary process that incorporates a wireless communication component in accordance with the present disclosure will now be described. For simplicity, the process will be described with reference to the exemplary environment 100 and the exemplary wireless communication component 150 described above with reference to FIGS. 1 through 4.

For example, FIG. 5 is a flowchart of a process 200 providing wireless signals in accordance with another implementation of the present disclosure. The process 200 is illustrated as a collection of blocks in a logical flow diagram, which represents a sequence of operations that can be implemented in hardware, software, or a combination thereof. In the context of software, the blocks may represent computer instructions that, when executed by one or more processors, perform the recited operations.

In this implementation, the process 200 includes providing modulated communication signals for transmission by a first antenna at 202. At 204, incoming signals from the first antenna and from a second antenna are continuously (or approximately continuously) received. The qualities of the incoming signals from the first and second antennas are monitored (or compared) at 206. If the quality of the incoming signal from the first antenna is better than (or equal to) the quality of the incoming signal from the second antenna, the transmissions are continued on the first antenna at 208. At 210, if the quality of the incoming signal from the second antenna is better than the quality of the incoming signal from the first antenna, the process 200 switches to transmitting on the second antenna. The process 200 continues (or terminates) at 212.

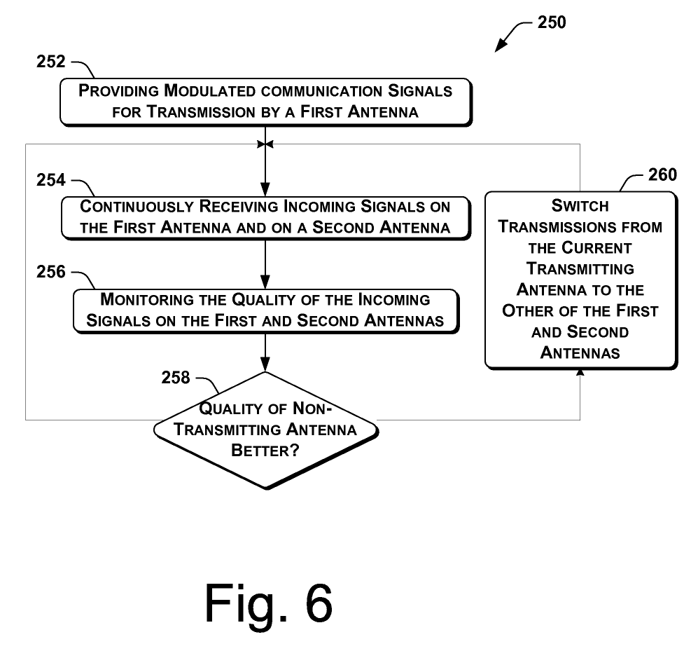

FIG. 6 is a flowchart of a process 250 providing wireless signals in accordance with yet another implementation of the present disclosure. In this implementation, the process 250 includes providing modulated communication signals for transmission by a first antenna at 252, and continuously (or approximately continuously) receiving incoming signals from the first antenna and from a second antenna at 254. The qualities of the incoming signals from the first and second antennas are monitored (or compared) at 256.

At a decision block 258, a determination is made whether the quality of the incoming signal from the non-transmitting antenna is better than the quality of the incoming signal from the transmitting antenna. If not, the process 250 returns to 254, and the above-described actions of continuously receiving incoming signals (254) and monitoring signal qualities (256) are continued. However, if it is determined at 258 that the quality of the incoming signal from the non-transmitting antenna is better than the quality of the incoming signal from the transmitting antenna, the process 250 switches transmitting from the currently-transmitting antenna to the other of the first and second antennas at 260, and returns to 254 to repeat the above-described activities 254 through 258. The process 250 may then repeat indefinitely (or terminate).

As noted above, implementations in accordance with the teachings of the present disclosure may provide considerable advantages. Processes in accordance with the present disclosure may advantageously ensure that transmissions are performed on a transmission frequency that provides a higher quality signal, thereby improving the effectiveness and reliability of wireless communications, particularly high speed data communications. By providing continuous monitoring of incoming transmissions on multiple frequencies, such implementations reduce or eliminate the need for switching back and forth between antennas as required by conventional systems to determine if that other antenna has the better receiving quality, thereby reducing or eliminating slots with non-optimum reception and transmission.

It will be appreciated that the processes 200, 250 described above and shown in FIGS. 5 and 6 are possible implementations in accordance with the teachings of the present disclosure, and that alternate implementations of processes may be conceived. For example, in alternate implementations, certain acts need not be performed in the order described, and may be modified, combined, and/or may be omitted entirely, depending on the circumstances. In further implementations, processes in accordance with the present disclosure may be conceived that operate with hardware components other than those exemplary components described above with respect to FIGS. 1 through 4. Moreover, in various implementations, the acts described may be implemented by a computer, processor, or other computing device based on instructions stored on one or more computer-readable media. The computer-readable media can be any available media that can be accessed by a computing device to implement the instructions stored thereon.

### CONCLUSION

For the purposes of this disclosure and the claims that follow, the terms “coupled” and “connected” may have been used to describe how various elements interface. Such described interfacing of various elements may be either direct or indirect. Moreover, although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims. Accordingly, the scope of the invention should not be limited by the disclosure of the specific implementations set forth above. Instead, the invention should be determined entirely by reference to the claims that follow.

We claim:

1. A method, comprising:
providing a communication signal for transmission by one of a first antenna and a second antenna;
monitoring first and second incoming signals received by the first and second antennas, respectively;
determining which of the first and second incoming signals is of better quality; and
if the incoming signal of a non-transmitting one of the first and second antennas is of better quality, switching transmission of the communication signal to the non-transmitting one of the first and second antennas.

2. The method of claim 1, wherein providing a communication signal includes providing a modulated communication signal.

3. The method of claim 1, wherein providing a communication signal for transmission by one of a first antenna and a second antenna includes providing a communication signal through a switch positioned in a first configuration for transmission of the communication signal by one of the first and second antennas.

4. The method of claim 3, wherein switching transmission of the communication signal to the non-transmitting one of the first and second antennas includes reconfiguring the switch to a second configuration for transmission of the communication signal to the non-transmitting one of the first and second antennas.

5. The method of claim 1, wherein providing a communication signal for transmission by one of a first antenna and a second antenna includes providing a communication signal through a Double Pole Double Throw (DPDT) switch positioned in a first configuration for transmission of the communication signal by one of the first and second antennas.

6. The method of claim 1, wherein switching transmission of the communication signal to the non-transmitting one of the first and second antennas includes reconfiguring a Double Pole Double Throw (DPDT) switch for transmission of the communication signal to the non-transmitting one of the first and second antennas.

7. The method of claim 1, wherein:
providing a communication signal includes providing a communication signal on a first lead of a switch and routing the communication signal to the transmitting one of the first and second antennas via a second lead of the switch; and wherein
monitoring first and second incoming signals includes receiving the first incoming signal received by the transmitting one of the first and second antennas into the switch through the second lead and routing the first incoming signal through the first lead to a receiver.

8. The method of claim 7, wherein the receiver is a first receiver and wherein monitoring first and second incoming signals further includes receiving the second incoming signal received by the non-transmitting one of the first and second antennas into the switch through the third lead and routing the second incoming signal through a fourth lead to a second receiver.

9. The method of claim 8, wherein:
monitoring first and second incoming signals includes monitoring first and second incoming signals using a controller; and
switching transmission of the communication signal to the non-transmitting one of the first and second antennas includes switching transmission of the communication signal based on a control signal from the controller.

10. The method of claim 9, further comprising demodulating the first and second incoming signals prior to determining which of the first and second incoming signals is of better quality.

11. A circuit, comprising:
a first portion configured to provide a communication signal for transmission by one of a first antenna and a second antenna;
a second portion configured to monitor first and second incoming signals received by the first and second antennas, respectively;
a third portion configured to determine which of the first and second incoming signals is of better quality; and
a fourth portion configured to switch transmission of the communication signal to the non-transmitting one of the first and second antennas if the incoming signal of a non-transmitting one of the first and second antennas is of better quality.

12. The circuit of claim 11, wherein:
the first portion is further configured to provide a communication signal through a switch positioned in a first configuration for transmission of the communication signal by one of the first and second antennas; and wherein
the fourth portion is further configured to reconfigure the switch a second configuration for transmission of the communication signal to the non-transmitting one of the first and second antennas.

13. The circuit of claim 11, wherein:
the first portion is further configured to provide a communication signal on a first lead of a switch, and to route the communication signal to the transmitting one of the first and second antennas via a second lead of the switch; and wherein
the second portion is further configured to receive the first incoming signal received by the transmitting one of the first and second antennas into the switch through the second lead, and to route the first incoming signal through the first lead to a first receiver.

14. The circuit of claim 13, wherein the second portion is further configured to receive the second incoming signal received by the non-transmitting one of the first and second antennas into the switch through the third lead, and to route the second incoming signal through a fourth lead to a second receiver.

15. The circuit of claim 11, wherein:
the second portion is configured to monitor the first and second incoming signals using a controller; and
the fourth portion is configured to switch transmission of the communication signal to the non-transmitting one of the first and second antennas based on a control signal from the controller.

16. An electronic device, comprising:
a processor; and
a communication component operatively coupled to the processor and including a first antenna and a second antenna, at least one of the processor and the communication component being configured to:
provide a communication signal for transmission by one of the first and second antennas;
monitor first and second incoming signals received by the first and second antennas, respectively;
determine which of the first and second incoming signals is of better quality; and
switch transmission of the communication signal to the non-transmitting one of the first and second antennas if the incoming signal of a non-transmitting one of the first and second antennas is of better quality.

17. The electronic device of claim 16, wherein at least one of the processor and the communication component is further configured to: provide a communication signal through a switch positioned in a first configuration for transmission of the communication signal by one of the first and second antennas; and reconfigure the switch a second configuration for transmission of the communication signal to the non-transmitting one of the first and second antennas.

18. The electronic device of claim 16, wherein at least one of the processor and the communication component is further configured to:
provide a communication signal on a first lead of a switch, and to route the communication signal to the transmitting one of the first and second antennas via a second lead of the switch; and
receive the first incoming signal received by the transmitting one of the first and second antennas into the switch through the second lead, and to route the first incoming signal through the first lead to a receiver.

19. The electronic device of claim 18, wherein the receiver is a first receiver and wherein at least one of the processor and the communication component is further configured to receive the second incoming signal received by the non-transmitting one of the first and second antennas into the switch through the third lead, and to route the second incoming signal through a fourth lead to a second receiver.

20. The electronic device of claim 16, wherein at least one of the processor and the communication component is further configured to: monitor the first and second incoming signals using a controller; and switch transmission of the communication signal to the non-transmitting one of the first and second antennas based on a control signal from the controller.
